(19) United States
(12) Patent Application Publication
(10) Pub. No.: US 2019/0064626 A1
(43) Pub. Date: Feb. 28, 2019

(54) Fabrication method for light valve

(71) Applicant: 1-Material Inc, Dorval (CA)

(72) Inventors: Haining Zhu, Lasalle (CA); Yuliang Zhang, Montreal (CA); Dawei Zhang, Lachine (CA); Shiyong Zhao, Longueuil (CA); Shuyong Xiao, St-Laurent (CA)

(73) Assignee: 1-Material Inc, Dorval (CA)

(21) Appl. No.: 15/692,465

(22) Filed: Aug. 31, 2017

(51) Int. Cl. G02F 1/17

(52) U.S. Cl. CPC G02F 1/172; B32B 17/10532

(57) ABSTRACT

The invention provides a new method to make suspension particle display based light valve, wherein the SPD device is assembled by stacking two separate parts together. The invented method reduces the photoinitiator amount required and thus reduce the degradation of the SPD performance.

### TECHNICAL FIELD

The present invention is related to a light valve, more specifically is related to a light valve which is capable of electronically controlling the light transmittance, and such a device is preferably used for windows, display elements, and alternate products of liquid crystal light control device,and a light shutter such as a sun roof.

### BACKGROUND ART

Technically, light value is a device which can regulate the amount of light missing through a media like a water valve which can control the water flow. Window shade can be viewed as a light value too. But in this invention, the light value is referred as a device which can electronically control the light transmittance, and such a device is scientifically referred as an electrochromic device. Depending on science behind an electrochromic device, it can be further classified as polymer dispersed liquid crystal (PDLC), electrochemical device (EC) and suspension particle display(SPD).

In practice, all the above three classes of electrochromic devices are assembled by sandwiching an electric active component between two transparent electrodes. In the case of PDLC, the electric active component is a kind of liquid crystal which transforms crystal structure in electromagnetic field applying via two transparent electrodes such as the device disclosed in U.S. Pat. No. 3,585,381A; in the case of EC, the electric active component is a kind of chemical which undergoes redox reaction in electromagnetic field applying via two transparent electrodes such as the device disclosed in U.S. Pat. No. 9,581,877B2, and in the case of SPD, the electric active component is a kind of particles which can re-orient in electromagnetic field applying via two transparent electrodes such as the device disclosed in U.S. Pat. No. 8,059,331B2 and U.S. Pat. No. 9,638,979B2. Hereinafter, the light valve in this invention is specifically related to SPD.

A typical SPD is made by sandwiching a light control layer between two transparent electroconductive substrates, referred as transparent electrodes. The light control layer is generally obtained by dispersing a light control suspension which contains light control particles into a resin matrix, wherein the light control particles respond to an electric field. More specifically in this kind of light valves, the light control particles absorb, scatter or reflect light by Brownian motion in the state that no electric field is applied thereto; thus, incident light into the film cannot penetrate through the film. When an electric field is applied thereto, the light control particles are oriented in the direction parallel to the electric field by the polarization of the particles; thus, incident light to the film can penetrate through the film. Therefore, in such a light valve, the amount of transmitted light is adjusted in accordance with the response of light control particles to an electric field.

Structurally, the light control layer in a SPD light valve is typically a polymeric matrix in solid form which contains droplets of the light control suspension in liquid form, and inside these droplets the light control particles in solid form of certain shape and size are embedded. To simplify the description of this SPD system in the text of this invention, polymeric matrix is referred as polymeric matrix (PM), the liquid suspension making up the droplets is referred as suspension medium (SM) and the light controlling particles encapsulated inside the SM is referred as light control particles (LCP). In practice, the solid form of polymeric matrix(PM) is mostly formed by polymerization of the corresponding monomers or oligomers, referred as precursors of PM (PPM) by photo-polymerization; thus an emulsion containing PPM, SM, LCP and photoinitiator (PI) is formulated such that this emulsion can be coated onto a transparent electrode by traditional coating methods including doctor-blade coating, screen printing and slot-die coating, then the wet coated layer is subsequently solidified (or named cured) by exposure to a ultraviolet (UV) irradiation.

To control the light transmission by an electric field, the size and shape of LCP is the key, which is normally in the range of 0.1 to 1 micrometer in length. With such a length of LCP, the size of droplet is thus required to be in order of 1-10 micrometers in order to host a few LCP inside each droplet. Therefore, the overall thickness of the light control layer is required to be in the order of tens to hundreds micrometer.

In prior arts of fabrication, the formulated SPD emulsion is coated onto a transparent electrode in a thickness of tens to hundreds micrometers, then subjected to strong an UV irradiation for a long period in order to effectively cure the emulsion, scientifically speaking to effectively polymerize the PPM materials within the coated wet layer. Still for efficient curing, a high content of photoinitiator(PI) is formulated into the SPD emulsion, and any by-products induced by large amount of photoinitiator and/or the residue of photoinitiator remained inside the final light control film may cause negative impact on the performance of the final SPD device, such as altering the shade of the SPD device and ultimately reducing the lifetime of the SPD device. On the other hand, most practical applications require a very dark off state (lower than 1%) of the transmittance for more privacy. The typical methods to meet the requirements are either increasing the thickness of light control layer (LCL) or increasing the loading of LCP, which is defined by SM to PMP ratio (SM:PMP) in the formulated SPD emulsion. However, increasing the thickness of LCL raises the cost and the curing time, while increasing the loading of LCP results in poor curing quality.

Therefore, it is highly demand commercially and practically to search for an improved SPD device fabrication method which can reduce the amount of photoinitiator needed for effective curing the SPD emulsion, therefore the curing time can be shorten and the stability of the fabricated SPD device can be increased. Meanwhile, the loading of LCP can be increased to achieve a relatively lower transmittance at the off-state, and reduce the cost by reducing the thickness of LCL.

### SUMMARY OF THE INVENTION

This invention provides a new method for fabricating light valve device basing on SPD. Specifically, this invention discloses a layer to layer method to effectively cure an SPD emulsion, where the SPD device is simply fabricated by lamination of two separate parts together, each part consists of a thin layer of LCL on a transparent electrode, in contrast to the prior art where a thick layer of LCL is only coated on one side of transparent electrode.

### BRIEF DESCRIPTION OF THE DRAWINGS

FIG. 1 presents schematically the light controlling device, wherein, a layer of light control layer (LCL) is sandwiched between two electrodes (ET). The light control layer (LCL) consists suspended particles or called light control particles (LCP, 310) in droplets(320) embedded in polymeric matrix(300). The electrode(ET) is made up of a layer of transparent conductive film(200) on a transparent substrate(100). In this invention, two identical electrodes are selected, therefore the transparent conductive film(400) is equivalent to transparent conductive film(200) and transparent substrate (500) is equivalent to transparent substrate(100).

FIG. 2 presents the typical fabrication method in prior arts, wherein the light control layer AB, consisting of polymeric matrix(300) containing suspended particles(310) in droplets(320). The light control layer AB was coated on one sheet of transparent electrode(ET) consisting of transparent conducting layer(400) on transparent substrate(500) and then laminated with another sheet of transparent electrode (ET) consisting of transparent conducting layer(200) on transparent substrate(100). The thickness of the light control layer AB is ab.

FIG. 3 presents the invented fabrication method, wherein the whole SPD device is fabricated by stacking two individual parts, Part-1 and Part-2; Part-1 is made of light control layer A coated on one sheet of transparent electrode(ET) consisting of transparent conducting layer(400) on transparent substrate(500); wherein the light control layer A consists of polymeric matrix(300) containing suspended particles(310) in droplets(320) and its thickness is a Part-2 is made of light control layer B coated on one sheet of transparent electrode(ET) consisting of transparent conducting layer (200) on transparent substrate(100); where the light control layer B consists of polymeric matrix(300) containing suspended particles(310) in droplets(320) and its thickness is b.

### DETAILED DESCRIPTION OF THE INVENTION

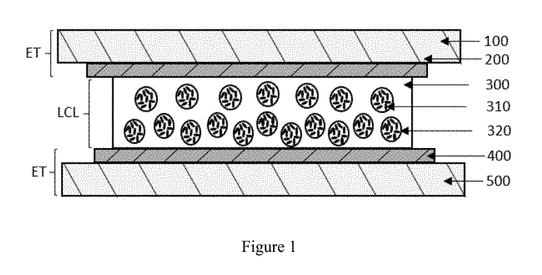

As depicted in FIG. 1, the SPD device consists of a light control layer (LCL) sandwiched between the two transparent electrodes(ET), and the light control layer (LCL) consists of polymeric matrix (300) containing suspended particles or named light control particles (LCP, 310) in droplets(320). In the state that no electric field is applied between two transparent electrodes, the light control particles(LCP) which are floated and dispersed in a flowing state in the droplets absorb, scatter or reflect light by Brownian motion; thus, light radiated into the film can hardly penetrate through the film. However, when an electric field is applied to the light control film, the light control particles(LCP) are arranged in the direction parallel to the electric field since the light control particles have electric dipole moment; thus, light radiated into the film comes to penetrate through the film. In this way, the light control particles respond to the applied electric field, whereby the amount of transmitted light comes to be adjustable.

Scientifically, it is the orientation of the light control particles inside the light control layer manipulated by external electric field which controls the transmittance of the light through the film. In order for these particles to orient freely, freedom around these particles are desired, thus these particles are often encapsulated in droplets. However, for safety and applications, these droplets are preferably embedded inside a solid medium referred as a polymeric matrix, thus a solid light control layer can be fabricated.

Still in practice, the solid form of polymeric matrix is mostly formed by polymerization of the corresponding monomers or oligomers, referred as precursors of PM(PPM) by photo-polymerization; thus an emulsion containing PPM, SM, LCP and photoinitiator(PI) is formulated such that this emulsion can be coated onto a transparent electrode by traditional coating methods including doctor-blade coating, screen printing, and slot-die coating, then the wet coated layer is subsequently solidified (or named cured) by exposure to an ultraviolet(UV) irradiation.

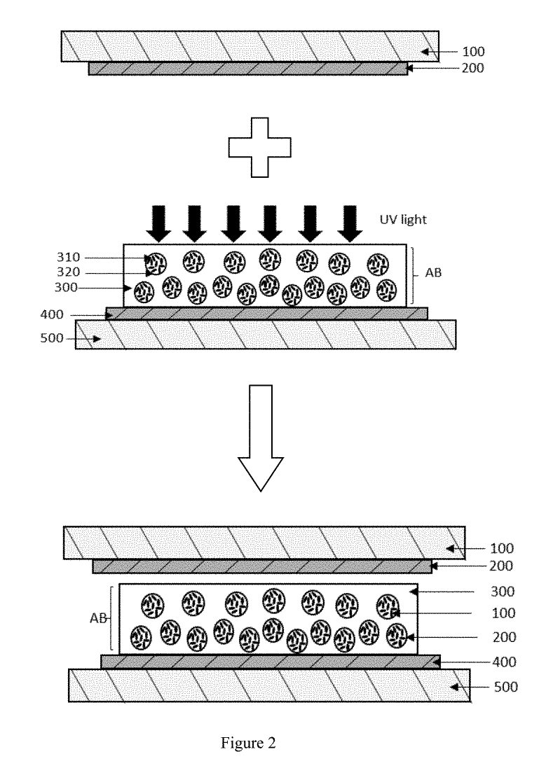

When the polymeric matrix precursor is cured, the photoinitiator is decomposed by UV irradiation, and the decomposed products often causes serious damage to light control layer. Therefore, the content of photoinitiator to be formulated into the SPD emulsion shall be as less as possible. According to prior arts as exampled in FIG. 2, the formulated SPD emulsion was first applied onto one transparent electrode 200/100 by doctor blade method to achieve a thickness of about 100-200 μm, then was exposed to an UV-radiation to cure the emulsion and form the layer 300 on top of the electrode 200/100; finally, another transparent electrode 400/100 was placed on the top of the layer 300 to complete the assembly of a SPD device. According to this fabrication method, in order to achieve a relatively low light transmission in dark state, a relatively thick film in the range of hundred of micrometer thick is required. Consequently, in order to effectively cure such a thick film, a relatively large amount of photoinitiator in the range of a few percentage by weight with respect the final SPD emulsion is required. Thus, large amount of decomposed products from photoinitiator and/or residue of photoinitiator may remain inside the light control layer of the final SPD device, which often cause the degradation of the deice performance.

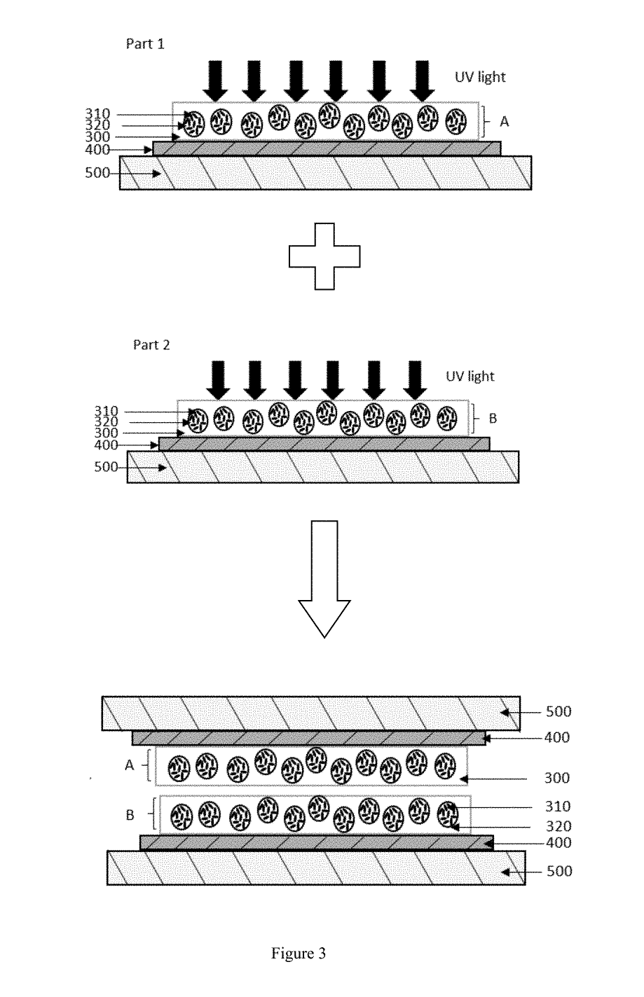

The new method presented in this invention can reduce the amount of photoinitiator required in a SPD emulsion, thus reduce the degradation of the SPD device performance. According to the present invention, as schematically in FIG. 3, the formulated SPD emulsion was first applied onto one transparent electrode 200/100 by doctor blading to achieve a thickness of about 10-100 μm, then was exposed to an UV-radiation to cure the emulsion and form the layer 300 on top of the transparent electrode 200/100 to complete Part-1; Similarly, Part-2 was prepared by coating the SPD emulsion on another transparent electrode. Finally layer 300 of each part (A and B) was stacking together face to face to complete the assembly of a SPD device.

According to this invention as illustrated in FIG. 3, the said polymeric matrix for light control layer is preferably a high light transmittance plastic material. More preferably, the said polymeric matrix 300 can be formed by photo-curing, so the shrinkage of this layer can be technically controlled. Still more preferably, the said polymeric matrix is a cross-linked polysiloxane formed from liquid siloxane copolymer with ethylenically unsaturated bond by photo-curing method described in U.S. Pat. Nos. 6,900,923 and 7,791,788. Hereinafter, the photo-curable polysiloxane which is used to form the polymeric matrix layer 300 is referred as the polymeric matrix precursor (PMP). The optical transmittance is related to the thickness of the layer, and such a thickness is preferably between 20-200 μm, more preferably, 50-120 μm.

According to this invention as illustrated in FIG. 3, the said polymeric matrix layer(300) embeds many droplets(320) and each droplet(320) encapsulates multiple particles(310), and these particles(310) are capable of re-orientation in an electronic field. Hereinafter, the droplet material(320) is referred as the suspension media (SM) and the particles are referred as light control particles (LCP) for scientific proposal.

As illustrated in FIG. 3, the SM, i.e., the material to form droplet(320) shall be different from the PPM material, and shall keep in a liquid form or at least a gel form within the PM. If the PM is an acrylate, the said SM is preferably selected from silicone oil or TDTM(Tri-Isodecyltrimellitate), or a mixture of any two and more materials as listed in U.S. Pat. Nos. 6,900,923 and 7,791,788.

As illustrated in FIG. 3, the said LCP which are encapsulated inside the said droplet (310) shall be capable of re-orientating themselves in an electronic field. Not only shall the chemical nature of the LCP but also the geometric dimension of the LCP be scientifically optimized. In terms of geometric dimension, the optimized LCP is preferably having a length of about 100-500 nm, more preferably 150-300 nm, and a diameter of 20-100 nm, more preferably 30-60 nm. The chemical composition of the said LCP is preferably selected from titanium dioxide (TiO₂), polyhalides and herapathite. More preferably, LCP is composed of calcium polyhalide, as listed in U.S. Pat. No. 8,520,294.

Practically, according to this invention, the said PMP material, the said SM(320) material and the said LCP(310) are formulated into an emulsion, hereinafter referred as a SPD emulsion. The SPD emulsion can be applied onto the surface of a substrate by conventional coating methods to form a wet coated layer, and then the wet coated layer can be solidified by photo-polymerization of PMP via a conventional ultraviolet(UV) irradiation. Other additives including stabilizer and/or emulsifier may also be added into this formulated SPD emulsion.

Still in common practice, the layer 100 and the layer 500 are PET film, and the layer 200 and the layer 400 are ITO film. In this invention, the ITO film 200 and the ITO film 400 were already pre-coated onto the PET film 100 and 500 to have two identical transparent conductive film (TCF) films, or named transparent electrodes, 200/100 and 400/500.

### EXAMPLES

Hereinafter, the present invention will be more specifically described by way of examples of the present invention and comparative examples.

In the following examples, the commercially available ITO/PET film was selected as the transparent electrode(ET), and the light transmittance of the ITO/PET film is 87% and the sheet resistance of the ITO/PET film is 400 ohm/square. The selected polymer matrix precursor(PMP) is a liquid siloxane copolymer with ethylenically unsaturated bond, which is synthesized by following a method that described in U.S. Pat. Nos. 6,900,923 and 7,791,788. The selected suspension medium(SM) is a mixture of silicone oil and TDTM(Tri-Isodecyltrimellitate) as listed in U.S. Pat. Nos. 6,900,923 and 7,791,788. The selected light control particles (LCP) are composed of calcium polyhalide as described in U.S. Pat. No. 8,520,294. The doctor blade coater (Model: MSK-AFA-III-110, MTI Corporation) was used to coat the SPD emulsion onto the selected transparent electrode. The UV light source is a commercially available metal halide lamp having a cumulative light dose of 1000 mJ/cm².

### Example 1

In a 100 ml glass flask, 0.15 g of photoinitiator(PI), bis(2,4,6-trimethylbenzoyl)-phenylphosphine oxide (purchased from Sigma-Aldrich), was first dissolved in 5 g of Acetone, then 15 g of the elected polymeric matrix precursor (PMP) was added. After thoroughly mixing by shaking, acetone was subsequently removed by a rotary evaporator to yield a liquid solution of PMP-PI, which is reserved for further use in formulating the SPD emulsion.

In another 100 ml glass flask, 1 g of the selected LCP was dispersed into 12 g of the selected SM by agitation to have a homogenous dispersion of LCP-SM.

The SPD Emulsion-1 was then formulated by mixing 2 g of LCP-SM dispersion prepared above with 6 g of PMP-PI solution prepared above in a separate 50 ml glass flask.

Example 1 is an example of prior art. In this example, the SPD Emulsion-1 was coated onto the selected ITO/PET film by the doctor blade to produce a wet thickness of 120 μm at room temperature under a coating speed of 10 mm/s. The coated wet emulsion was exposed to the UV light source for 1 minutes to yield a solid light control layer on ITO/PET sheet (referred as LCL/ITO/PET). Another fresh sheet of ITO/PET without light control layer was finally laminated with this LCL/ITO/PET at room temperature to complete the assembly of the SPD device-1.

### Example 2

Example 2 is an example of the present invention. The same materials used in the Example-1 are used, where Part-1 was obtained by coating SPD Emulsion-1 onto the selected ITO/PET electrode but with a thickness of 60 μm of light control layer instead of 120 μm in Example-1. Part-2 was made the same as Part-1. Finally, Part-1 and Part-2 were simply laminated together in room temperature to complete the assembly of the SPD device-2.

### Example 3

The same as example 1, except the photoinitiator content is 1.5% instead of 1% in the SPD emulsion, and thus obtained SPD emulsion is referred as SPD Emulsion-3 and the SPD device made from this emulsion by following procedures described in Example-1 is referred the SPD device-3.

### Example 4

The SPD Emulsion-4 was formulated by mixing 2 g of LCP-SM dispersion prepared above with 4 g of PMP-PI solution prepared above. In this example 4, The SPD Emulsion-4 was coated onto the selected ITO/PET film by the doctor blade to produce a wet thickness of 80 μm at room temperature under a coating speed of 10 mm/s. The coated wet emulsion was exposed to the UV light source for 40 s to yield a solid light control layer on ITO/PET sheet (referred as LCL/ITO/PET). Another fresh sheet of ITO/PET without light control layer was finally laminated with this LCL/ITO/PET at room temperature to complete the assembly of the SPD device-4.

### Example 5

The SPD device-5 was made from the same materials used in the Example-4 with the invented method instead of the prior art method. Part-1 was obtained by coating SPD Emulsion-4 onto the selected ITO/PET electrode but with a thickness of 40 μm of light control layer instead of 80 μm in Example-4. Part-2 was made the same as Part-1. Finally, Part-1 and Part-2 were simply laminated together in room temperature to complete the assembly of the SPD device-5.

### Example 6

the SPD device-6 was made according to prior art method. The SPD emulsion-6 was obtained from SPD Emulsion-4 by adjusting the photoinitiator content from 1% to 1.5% by weight, and the SPD device-6 was then made from this SPD Emulsion-6, and the thickness of the light control layer in the SPD device-6 was 120 μm instead of 80 μm in example 4.

### Example 7

The SPD device-7 was made according to the invented method by using same materials used in the Example-6. Part-1 was obtained by coating the SPD Emulsion-6 onto the selected ITO/PET electrode but with a thickness of 60 μm of light control layer instead of 120 μm in Example-6. Part-2 was made the same as Part-1. Finally, Part-1 and Part-2 were simply laminated together in room temperature to complete the assembly of the SPD device-7.

For any SPD devices exampled above, three key characters, naming curing quality, light controlling quality and adhesiveness are evaluated. The evaluating method of each character is illustrated below.

[Curing Quality]

With respect to the curing quality, it reflects the degree of polymerization of PMP. The light control layer with the poor curing quality was wet and very sticky. As long as there is any liquid, no matter the liquid is on the top surface of the light control layer, in the middle of the light control layer or in between the light control layer and the ITO/PET substrate, the light control layer is regarded as the poor curing quality. The lamination of the light control layer with poor curing quality would squeeze the light control layer to spread and destroy the light control device. The light control layer with good curing quality would yield a strong and solid device. A scale of 1-10 was assigned by visual inspection to compare the curing quality of these SPD devices. A scale of 1-3 represents very poor quality that neither the surface nor the interior of the light control layer is cured or semi-cured; a scale of 3 to 6 represents medium curing quality that only the surface is cured and the interior is neither cured nor semi-cured; a scale of 6 to 10 represents good curing quality that the whole light control layer is throughout cured.

[Light Control Quality]

The light controlling quality reflects the difference of light transmission between on-state and off-state of the SPD device. The light transmittance was measured by a LS183 spectrometer (Linshang Technology), the transmittance takes the average of transmittance at the spectral range from 380 nm to 760 nm. The off-state transmittance was measured when no applied voltage was applied to the SPD device. The on-state transmittance was measured when 200V AC with the frequency of 60 Hz was applied to the SPD device.

[Adhesiveness]

The adhesiveness reflects the physical integral of the final SPD device against external physical force. The adhesiveness was assessed by the traditional peeling test. A sample piece of 20 mm×100 mm was cut from each of the SPD device prepared in Example 2 and 3. Then, 25 mm of one end of the transparent electrode on the upward side in the longitudinal direction was cut away, while 25 mm of the other end of transparent electrode on the downward side was cut away alternately. The light control layer regions naked in both end regions were wiped away to create a test piece. In the testing, a spring scale was used to pull the test piece in the longitudinal direction. In this way, the breaking load was measured and used an indication of the adhesiveness level.

Table-1 and Table-2 summarize the assessing results of the exampled devices.

TABLE 1
Assessed results of SPD devices 1-3

| SPD | PI | Fabrication | Curing | Adhesiveness |
|---|---|---|---|---|
| device No. | content | method | quality | (kg) |
| 1 | 1% | Prior Art | 3 | NA |
| 2 | 1% | This Invention | 9 | 8.8 |
| 3 | 1.5% | Prior Art | 7 | 5.6 |

From Table-1, it is seen that the curing quality of the SPD device-2(this invention) is better than the SPD device-1 (prior art). Compared with the prior art method, the invented method produced light control layer with good curing quality. Also, the adhesive quality of the SPD device-2(this invention) is higher than that of the SPD device-1(prior art). A high adhesive quality means it is very difficult to peel off the light control devices and is more suitable for the commercial products.

Further from Table-1, it is seen that more photoinitiator is needed to achieve the same curing quality for the SPD device-3(prior art) than for the SPD device-2(this invention). As a result, the invented method reduced the amount of the photoinitiator required and then reduced the potential problems caused by over-dosing of photoinitiator.

TABLE 2
Comparison of assessed results for SPD devices 3-7

| Sam- | | | Thick- | PI | | |
|---|---|---|---|---|---|---|
| ple | Processing | | ness | con- | Curing | |
| No. | method | SM:PMP | (μm) | tent | Quality | Transmittance |
| 3 | Prior art | 1:3 | 120 | 1.5% | 7 | 1.8%-52.2% |
| 4 | Prior art | 1:2 | 80 | 1% | 5 | NA |
| 5 | This | 1:2 | 80 | 1% | 9 | 1.6%-53.4% |
| | invention | | | | | |
| 6 | Prior art | 1:2 | 120 | 1.5% | 2 | NA |
| 7 | This | 1:2 | 120 | 1.5% | 8 | 0.4%-45.7% |
| | invention | | | | | |

As summarized in Table-2, the light control layer is thinner in the SPD device-4(this invention) than SPD device-3(prior art), though these two devices exhibit the same transmittance. So the invented method can reduce the cost of materials, compared with the prior art method. Also, the transmittance for the off-state of the SPD device-7(this invention) is lower than that of the SPD device-3(prior art), which implies that the invented method is easier to achieve the light control devices with low transmittance at off-state.

Although both the prior art method and the invented method can be used to make SPD devices with a low ratio of SM to PMP of 1:3; the prior art method had a difficult to make SPD devices with a high ratio of SM to PMP of 1:2. Referring to the SPD device-4, 5,6, and 7 in Table 2, it is seen that with higher ratio of SM to PMP, the light control layer is more difficult to be cured. However, a higher ratio of SM to PMP is favorable to achieve a light control device with the low transmittance at off-state, which is mostly required by commercial light control products. Thus, the invented method is more applicable than the prior art method.

### REFERENCE

U.S. Patent Documents

U.S. Pat. No. 9,581,877 John David Bass et al. 2016

U.S. Pat. No. 3,585,381 Theodore L Hodson et al. 1971

U.S. Pat. No. 8,059,331 Osamu Higashida et al. 2010

U.S. Pat. No. 9,638,979 Osamu Higashida et al. 2010

U.S. Pat. No. 6,900,923 Srinivasan Chakrapani et al. 2005

U.S. Pat. No. 7,791,788 Steven M. Slovak et al. 2010

U.S. Pat. No. 8,520,294 Tooru Tanakaet al. 2011

1. A method of making a suspension particle based light valve by laminating a first part and a second part face to face, wherein the first part comprises a first light control layer on a first transparent electrode; the second part comprises a second light control layer on a second transparent electrode; wherein each of the first and second parts are cured prior to lamination.

2. The method of claim 1, wherein the second light control layer is the same as the first light control layer.

3. The method of claim 1, wherein the second transparent electrode is the same as the first transparent electrode.

4. The method of claim 1, wherein the thickness of each light control layer is between 10 μm and 100 μm.

5. The method of claim 1, wherein the light control layer in each of the first and second layers comprises a plurality of droplets dispersed in a polymeric matrix; and each droplet comprises a plurality of light control particles suspended in a suspension medium.

6. (canceled)

7. The method of claim 5, wherein the light control layer in each of the first and second layers is formed by:
a) applying an emulsion onto the respective transparent electrodes; and
b) curing the emulsion,
wherein the emulsion comprises a photoinitiator, a polymeric matrix precursor material, the suspension medium and the light control particles; and the suspension medium is distinct from the precursor material.

8. The method of claim 7 wherein the precursor material is a liquid siloxane copolymer.

9. The method of claim 7, wherein the polymeric matrix is an acrylate and the suspension medium is: a silicon oil, tri-isodecyltrimellitate or a mixture thereof.

10. The method of claim 5, wherein the light control particles are selected from the group consisting of titanium dioxide, polyhalides and herpathite.

11. The method of claim 10, wherein the light control particles are composed of calcium polyhalide.

12. The method of claim 5, wherein the light control particles have a length of from about 100 μm and about 500 μm.

13. The method of claim 5, wherein the light control particles have a diameter of from about 20 nm and about 100 nm.
